(19) United States
(12) Patent Application Publication
(10) Pub. No.: US 2013/0185464 A1
(43) Pub. Date: Jul. 18, 2013

(54) ELECTRONIC APPARATUS, DATA TRANSFER CONTROL METHOD, AND PROGRAM

(71) Applicant: Sony Corporation, Tokyo (JP)

(72) Inventor: Nobuaki BESSHO, Chiba (JP)

(73) Assignee: Sony Corporation, Tokyo (JP)

(21) Appl. No.: 13/739,277

(22) Filed: Jan. 11, 2013

(30) Foreign Application Priority Data
Jan. 18, 2012 (JP) 2012-007877

(51) Int. Cl. G06F 3/06

(52) U.S. Cl. CPC G06F 3/0653
USPC 710/18

(57) ABSTRACT

An electronic apparatus includes an information obtaining section that obtains performance information from an external storage device, and a control section that performs data transfer control based on the performance information that is obtained by the information obtaining section.

### BACKGROUND

The present technology relates to an electronic apparatus, a data transfer control method, and a program. More specifically, optimal data transfer control can be performed easily in accordance with a storage device that is added to the electronic apparatus externally.

In related art, an electronic apparatus is configured such that various storage devices can be connected to the electronic apparatus in order to perform recording and playback of various pieces of data, etc. In addition, it has been proposed that an information collection section that collects performance information on response of input and output processing and processing status information on the input and output processing is provided in the external storage device, and failure analysis is easily performed using the pieces of information that are collected by the information collection section (see Japanese Unexamined Patent Application Publication No. 2010-49613).

### SUMMARY

In connection of a storage device to an electronic apparatus, a generic interface is used so that various storage devices can be connected to the electronic apparatus. In addition, in the generic interface, by standards revision, acceleration of data transfer speed, etc. has been achieved while maintaining the upward compatibility. When the generic interface in which such acceleration, etc. has been achieved is used, there occurs a case in which a storage device that is compatible with a subordinate interface that is already in use is connected to the generic interface because the upward compatibility is maintained in the generic interface. Thus, even when a superordinate interface is used, the function of a storage device is often limited beforehand so as to be compatible with the interface that is already in use. For example, when the electronic apparatus has a function to record a broadcast program to an external storage device, the number of channels of broadcast programs that can be recorded simultaneously is limited for the external storage device beforehand so as to be compatible with the interface that is already in use.

In addition, in a storage device using a superordinate interface, there occurs a situation when the function of the storage device becomes limited because the performance of the storage device body is low and so the expected performance is not obtained in the superordinate interface, so that the performance of the whole storage device is unpredictable in addition to the specification of the interface.

In addition, when performance information is collected by providing an information collection section in the external storage device, the electronic apparatus can perform recording and playback by removing the function limitation based on the performance information that is collected in the information collection section while taking advantage of the performance of the external storage device. However, the cost of the external storage device is increased when the information collection section is provided in the external storage device. In addition, when a general external storage device in which the information collection section is not provided is connected to an interface, the removal of function limitation in accordance with the performance of the external storage device is difficult to be performed.

Therefore, it is desirable to provide an electronic apparatus, a data transfer control method, and a program by which data transfer control can be performed while taking advantage of the performance of the external storage device.

According to an embodiment of the present technology, there is provided an electronic apparatus that includes an information obtaining section that obtains performance information from an external storage device and a control section that performs data transfer control based on the performance information that is obtained by the information obtaining section.

In the present technology, the performance information is obtained from the external storage device. The performance information includes, for example, a performance measurement condition and a performance measurement result. When the performance measurement condition that is included in the performance information satisfies a desired condition, the performance information is determined to be available, and data transfer control is performed on the basis of the performance measurement result that is indicated by the performance information. In addition, when the performance information is difficult to be obtained from the external storage device or when the obtained performance information is not determined to be available, the performance information including the measurement result is generated by performing performance measurement of the external storage device, and is recorded, for example, to a user's area of the external storage device. As the performance measurement, access performance that meets an object of the electronic apparatus, such as random access performance or sequential access performance is measured.

In the data transfer control, the limitation of a function is performed on the external storage device on the basis of the performance information. For example, there is an upper limit of the number of contents that can be recorded and played back simultaneously to and in the external storage device, as the function limitation.

According to an embodiment of the present technology, there is provided a data transfer control method that includes obtaining performance information from an external storage device and performing data transfer control based on the obtained performance information.

According to an embodiment of the present technology, there is provided a program that causes a computer to control data transfer with an external storage device and causes the computer to execute procedures of obtaining performance information from the external storage device, and performing data transfer control based on the obtained performance information.

The program according to the present technology is, for example, a program that can be provided by a storage device medium such as an optical disk, a magnetic disk, and a semiconductor memory or a communication medium such as a network that are in a computer-readable format for a generic computer that can execute various program codes. The processing in accordance with the program is realized on the computer by providing such program in a computer-readable format.

According to the present technology, performance information is obtained from an external storage device, and data transfer control is performed on the basis of the obtained performance information. Therefore, data transfer control can be performed while taking advantage of the performance of the storage device that is added to an electronic apparatus externally.

### BRIEF DESCRIPTION OF THE DRAWINGS

FIG. 1 is a diagram illustrating a configuration of a system in which a storage device is connected to an electronic apparatus according to the present technology;

FIGS. 2A and 2B are illustrative diagrams illustrating recording of performance information;

FIG. 3 is a flowchart illustrating an operation of the electronic apparatus;

FIGS. 4A to 4C are diagrams for describing a data transfer control mode;

FIG. 5 is a diagram illustrating a schematic configuration of an electronic apparatus in which performance of sequential access is emphasized; and

FIG. 6 is a diagram illustrating a schematic configuration of an electronic apparatus in which performance of random access is emphasized.

### DETAILED DESCRIPTION OF EMBODIMENTS

The embodiments of the present technology are described below. The description is made in the following order:

1. Configuration and operation of a system

2. First embodiment

3. Second embodiment.

### 1. Configuration and Operation of a System

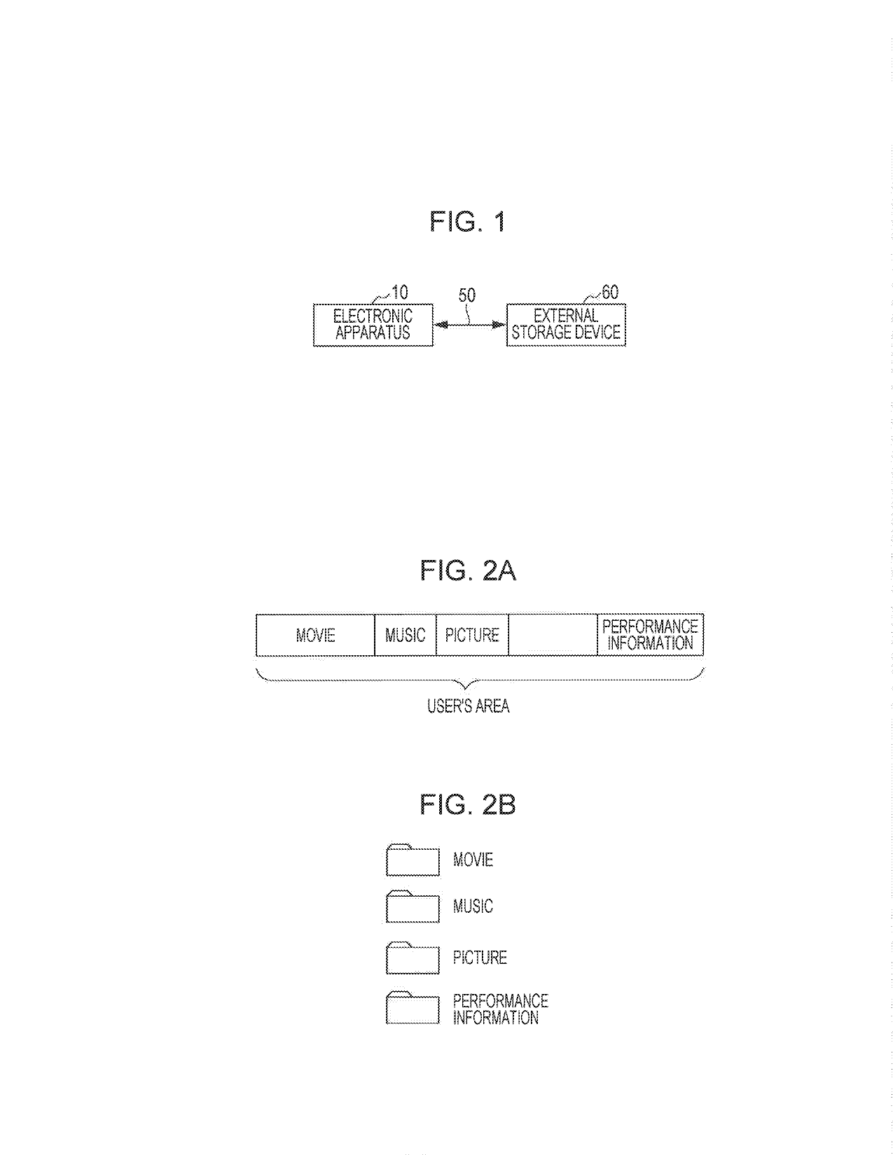

FIG. 1 is a diagram illustrating a configuration of a system in which a storage device is connected to an electronic apparatus according to the present technology. An electronic apparatus 10 is connected to an external storage device 60 through a generic interface 50.

The electronic apparatus 10 includes a function to record data to the external storage device 60 and a function to read data that is recorded to the external storage device 60. In addition, the electronic apparatus 10 includes a function to obtain performance information from the external storage device 60 and a function to perform data transfer control on the basis of the obtained performance information. In addition, the electronic apparatus 10 may include a function to measure the performance of the external storage device 60 and a function to record a measurement result and a measurement condition of the performance to the external storage device 60.

The generic interface 50 is an interface that is already in use. For example, the interface includes a universal serial bus (USB), external serial advanced technology attachment (eSATA), IEEE1394, LightPeak (Trademark), etc.

The external storage device 60 includes a storage device that can be connected to the generic interface 50, such as an external hard disk drive (HDD), an external solid state drive (SSD), a USB memory, and a card reader.

The electronic apparatus 10 determines whether or not performance information is recorded to the external storage device 60, and for example, when available performance information is recorded to the external storage device 60, the electronic apparatus 10 reads the performance information that is recoded to the external storage device 60. In addition, the electronic apparatus 10 performs data transfer control while taking advantage of the performance of the external storage device 60 on the basis of the read performance information.

The electronic apparatus 10 executes a program to measure the performance of the external storage device 60, for example, a benchmark test when performance information is not recorded to the external storage device 60 or when available performance information is not recorded to the external storage device 60. The electronic apparatus 10 performs data transfer control while taking advantage of the performance of the external storage device 60 on the basis of the performance measurement result. In addition, the electronic apparatus 10 generates performance information that includes a performance measurement result and a measurement condition and records the performance information to the external storage device 60. The performance information is recorded to a user's area so that reading of performance information can be performed in another electronic apparatus even when the external storage device 60 is connected to another electronic apparatus. For example, as illustrated in FIG. 2A, the performance information is recorded to the user's area to which user data such as movie data, music data, and picture data is recorded. In addition, as illustrated in FIG. 2B, a folder for performance information may be provided in the external storage to store performance information in the folder so that reading, check, etc. of the recorded performance information can be easily performed.

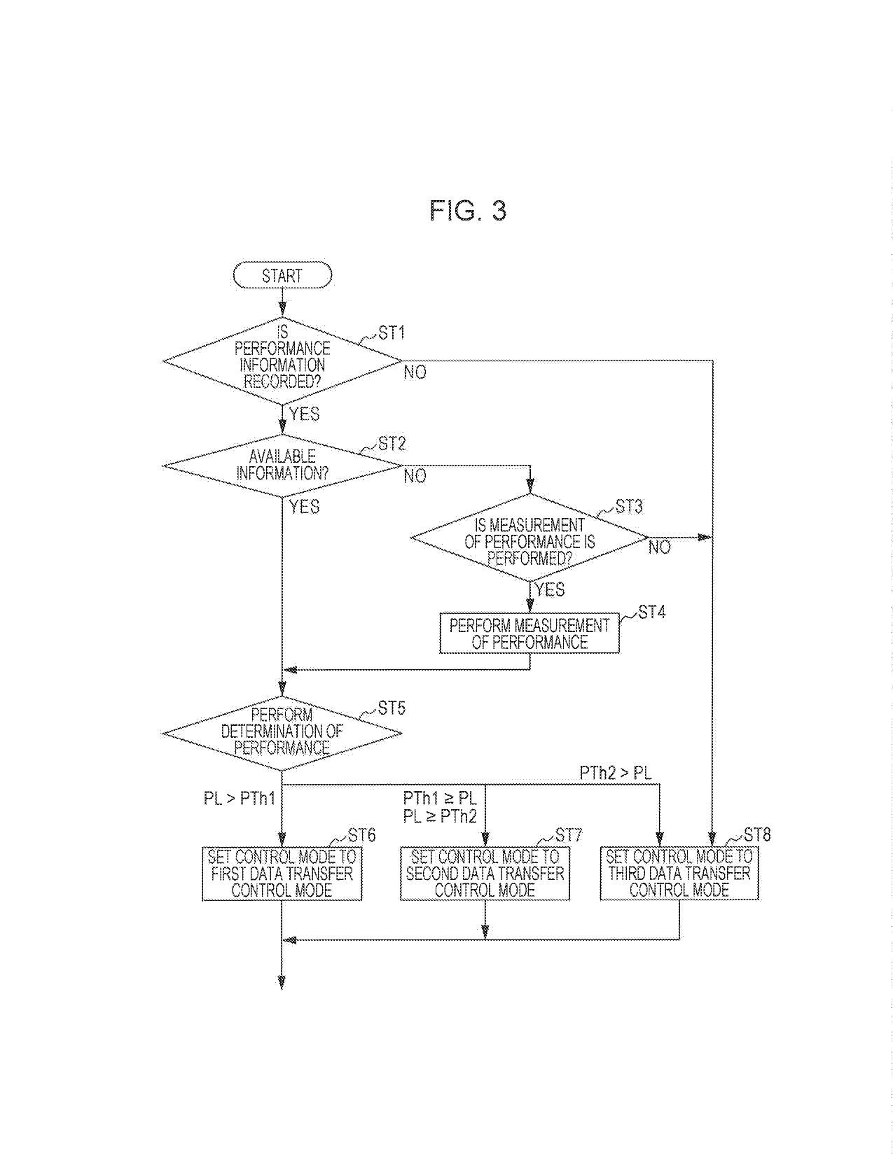

FIG. 3 is a flowchart illustrating an operation of the electronic apparatus. In FIG. 3, an example is illustrated in which one of a first data transfer control mode in which function limitation is not performed, a second data transfer control mode in which some function limitation is performed, and a third data transfer control mode in which a minimum function is executed is selected in accordance with the performance of the external storage device 60.

In Step ST1, the electronic apparatus 10 determines whether or not recording of performance information is performed. The electronic apparatus 10 determines whether or not performance information is recorded to a user's area of the external storage device 60 through the generic interface 50. The flow proceeds to Step ST2 when performance information is recorded to the user's area, and the flow proceeds to Step ST8 when performance information is not recorded to the user's area.

In Step ST2, the electronic apparatus 10 determines whether or not the performance information is available information. The electronic apparatus 10 obtains the performance information from the external storage device 60, and determines whether or not the performance information is information that is available for performing data transfer control. The flow proceeds to Step ST5 when the electronic apparatus 10 determines that a measurement result is information available for performing data transfer control on the basis of a measurement condition, which is included in the performance information, and the flow proceeds to Step ST3 when the electronic apparatus 10 does not determine that a measurement result is information available for performing data transfer control.

In Step ST3, the electronic apparatus 10 determines whether or not the performance is measured. The electronic apparatus 10 determines whether or not the performance is set to be measured when performance information is not recorded to the external storage device 60 or when the performance information that is read from the external storage device 60 is not available information. The flow proceeds to Step ST4 when the electronic apparatus 10 determines that the performance is set to be measured, and the flow proceeds to Step ST8 when the electronic apparatus determines that the performance is not set to be measured.

In Step ST4, the electronic apparatus 10 measures the performance. The electronic apparatus 10 measures the performance under a measurement condition in accordance with data transfer with the external storage device 60. In addition, the electronic apparatus 10 records the measurement result and the measurement condition of the performance to the user's area of the external storage device 60 as performance information, and the flow proceeds to Step ST5.

In Step ST5, the electronic apparatus 10 performs determination of the performance. When the electronic apparatus 10 determines that a performance level PL based on the measurement result of the performance of the external storage device 60 and the generic interface 50 are higher than a first performance level PTh1, the flow proceeds to Step ST6. In addition, when the electronic apparatus 10 determines that the performance level PL is within a range between the first performance level PTh1 and a second performance level PTh2 that is lower than the first performance level PTh1, the flow proceeds to Step ST7. In addition, when the electronic apparatus 10 determines that the performance level PL is lower than the second performance level PTh2, the flow proceeds to Step ST8. Regarding the performance level PL, for example, when a maximum data transfer speed of the generic interface 50 is lower than a data transfer speed that is indicated by the performance measurement result of the external storage device 60, the maximum data transfer speed of the generic interface 50 is regarded as the performance level PL. In addition, when the maximum data transfer speed of the generic interface 50 is higher than the data transfer speed that is indicated by the performance measurement result of the external storage device 60, the data transfer speed that is indicated in the performance measurement result is regarded as the performance level PL.

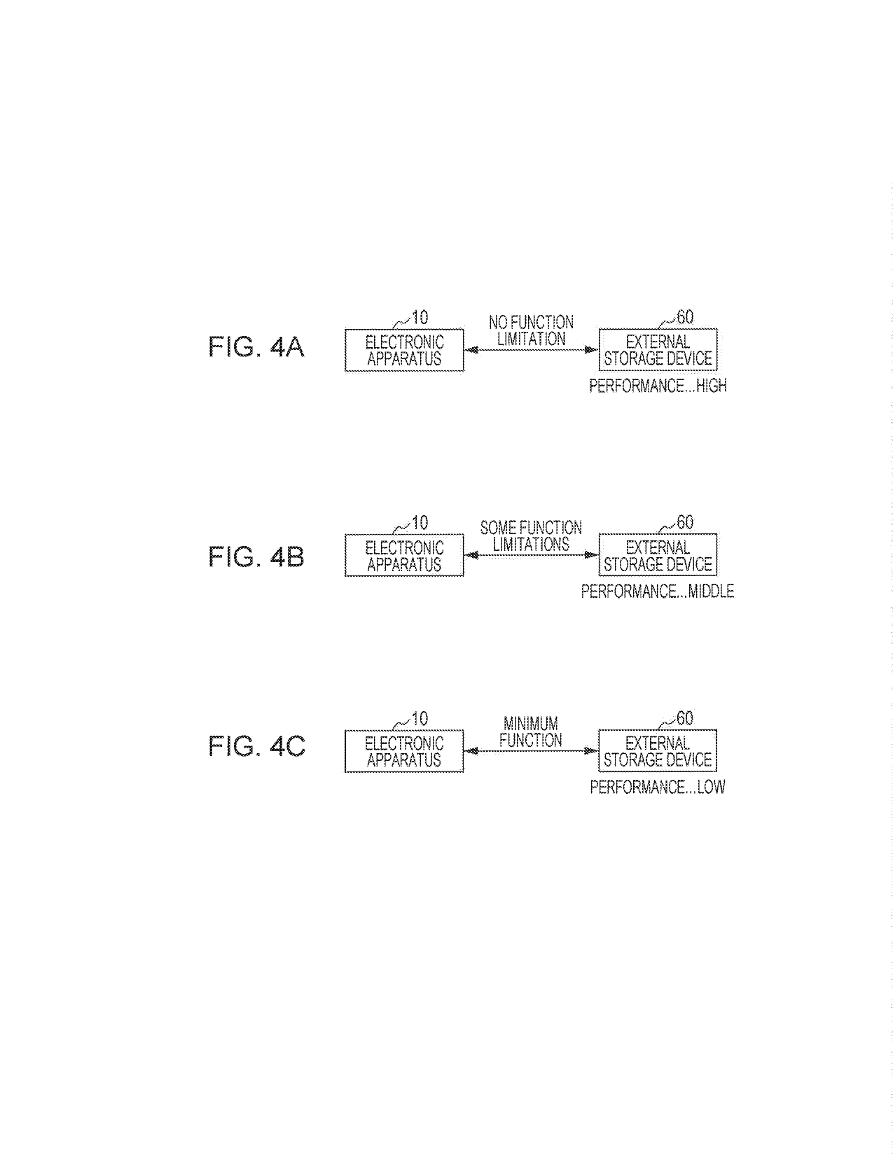

In Step ST6, the electronic apparatus 10 sets the control mode to a first data transfer control mode. The electronic apparatus 10 performs data transfer without function limitation by setting the control mode to the first data transfer control mode so that the external storage device 60 can be effectively used because the performance of the external storage device 60 is high. For example, as illustrated in FIG. 4A, when an external storage device having high performance is connected to the electronic apparatus 10, the electronic apparatus 10 performs data transfer without the function limitation.

In Step ST7, the electronic apparatus 10 sets the control mode to a second data transfer control mode. The electronic apparatus 10 performs data transfer in accordance with the performance of the external storage device 60 while limiting some functions by setting the control mode to the second data transfer control mode because the performance of the external storage device 60 is within a range between the first performance level and the second performance level. For example, as illustrated in FIG. 4B, when the performance of the external storage device is lower than the performance in FIG. 4A and higher than performance in FIG. 4C that is described later, the electronic apparatus 10 performs data transfer while limiting some functions.

In Step ST8, the electronic apparatus 10 sets the control mode to a third data transfer control mode. The electronic apparatus 10 performs data transfer with a minimum function by setting the control mode to the third data transfer control mode because the performance of the external storage device 60 is low. For example, as illustrated in FIG. 4C, when an external storage device having low performance is connected to the electronic apparatus 10, the electronic apparatus 10 performs data transfer with a minimum function.

As described above, when performance information is recorded to the external storage device 60, the electronic apparatus that is coupled to the external storage device 60 can perform data transfer so as to take advantage of the performance of the external storage device by controlling data transfer on the basis of the performance information that is recorded to the external storage device 60.

### 2. First Embodiment

Next, as a first embodiment, a case is described in which data transfer is performed by emphasizing the performance of sequential access in the electronic apparatus 10. For example, because a large amount of data is transferred continuously in transfer, etc. of encoded movie data, the performance of sequential access in the external storage device 60 is emphasized.

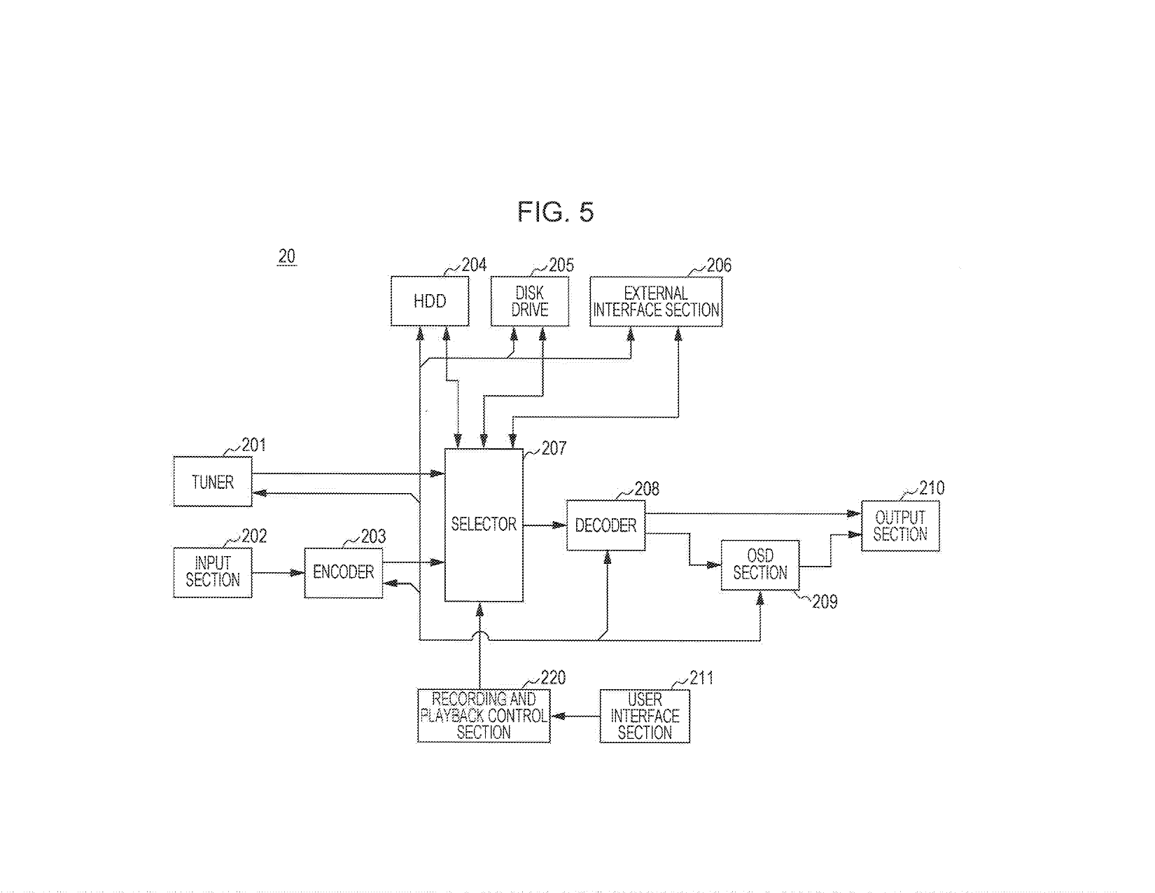

FIG. 5 is a diagram illustrating a schematic configuration of an electronic apparatus in which the performance of sequential access is emphasized, for example, a schematic configuration of a recording and playback device that performs recording and playback of a broadcast program and movie contents. For example, a recording and playback device 20 encodes image data and sound data of the received broadcast program and records the encoded data to a built-in recording medium or external storage device. In addition, for example, the recording and playback device 20 encodes image data and sound data that are obtained from another apparatus and records the encoded data to the built-in recording medium or external storage device. In addition, for example, the recording and playback device 20 performs decoding of the encoded data that is recorded to the built-in recording medium or external storage device in accordance with a user instruction, and performs output of the obtained sound data and image data.

The recording and playback device 20 includes a tuner 201, an input section 202, an encoder 203, a hard disk drive (HDD) 204, a disk drive 205, an external interface section 206, a selector 207, a decoder 208, an on-screen display (OSD) section 209, and an output section 210. In addition, the recording and playback device 20 includes a user interface section 211 and a recording and playback control section 220.

The tuner 201 extracts a signal of a desired channel from a broadcast signal that is received through an antenna (not illustrated), and demodulates the extracted signal. In addition, the tuner 201 outputs the encoded data that is obtained by the demodulation to the selector 207.

The input section 202 is an interface that is used to input image data and sound data that are supplied from an external apparatus in order to record data to the recording and playback device 20. The input section 202 supplies the input image data and sound data to the encoder 203.

The encoder 203 encodes image data and sound data when the image data and sound data that are supplied from the input section 202 are not encoded. The encoder 203 outputs the encoded data to the selector 207.

The HDD 204 performs recording of encoded data of an image and sound, etc., various programs, and another data. For example, the HDD 204 performs recording of encoded data of an image and sound that are supplied from the selector 207. In addition, the HDD 204 reads the recorded encoded data and outputs the read data to the selector 207.

The disk drive 205 records and reads data to and from a recording medium that is mounted to the disk drive 205. For example, the recording medium that is mounted to the disk drive 205 may be a DVD disk such as a digital versatile disc (DVD) video, a DVD-RAM, a DVD-R, a DVD-RW, a DVD+R, and a DVD+RW, a Blu-ray (Trademark) disk, etc. The disk drive 205 records encoded data of image and sound, etc. to the recording medium. In addition, the disk drive 205 reads the encoded data that is recorded to the recording medium and outputs the read data to the selector 207.

The external interface section 206 is an interface that is used to connect the recording and playback device 20 with an external storage device, etc. For example, the external interface section 206 is a generic interface such as the above-described USB, eSATA, IEEE1394, and LightPeak. The external interface section 206 outputs pieces of encoded data of an image and a sound that are supplied from the selector 207, to the external storage device. In addition, the external interface section 206 outputs encoded data that is supplied from the external storage device to the selector 207.

The selector 207 selects encoded data, etc. that is supplied from the tuner 201 or the encoder 203 at the time of recording of images and sounds. The selector 207 outputs the selected encoded data to the external storage device that is connected to the HDD 204, the disk drive 205, or the external interface section 206. In addition, the selector 207 outputs encoded data that is supplied from the external storage device that is connected to the HDD 204, the disk drive 205, or the external interface section 206, to the decoder 208, at the time of playback of image and sound.

The decoder 208 decodes encoded data and generates image data and sound data. The decoder 208 outputs the generated encoded data and the generated sound data to the OSD section 209 and the output section 210, respectively.

For example, the OSD section 209 performs processing for superimposing an image of a graphical user interface (GUI) such as a menu, a button, or a cursor, on a display image based on image data that is supplied from the decoder 208. The OSD section 209 outputs the image data obtained after the processing to the output section 210.

The output section 210 is an interface that is used to output image data and sound data to a display device and an acoustic output device, respectively.

The user interface section 211 is connected to the recording and playback control section 220. The user interface section 211 includes, for example, an operation button and an operation switch by which the user operates the recording and playback device 20, and a reception section of a remote control signal. The user interface section 211 detects an operation by the user through these configuration elements, generates an operation signal in accordance with the user operation, and outputs the generated signal to the recording and playback control section 220.

The recording and playback control section 220 includes a processor such as a central processing unit (CPU), a read only memory (ROM), and a random access memory (RAM). The memory stores a program that is executed by the CPU, program data, etc. The programs that are stored in the memory and the HDD 204 are executed when the CPU reads the programs. By executing the programs, for example, the CPU controls an operation of the recording and playback device in accordance with an operation signal that is input from the user interface section 211 and performs recording and playback of an image and sound that are desired by the user.

In addition, the recording and playback control section 220 controls recording of data to the external storage device 60, controls reading of data that is recorded to the external storage device 60, performs processing for obtaining performance information from the external storage device, and controls data transfer based on the obtained performance information. In addition, the recording and playback control section 220 performs processing for measuring the performance of the external storage device 60, performs processing for generating performance information that includes a measurement result and a measurement condition of the performance, and controls recording of the generated performance information to the external storage device 60, etc.

The recording and playback device 20 that is configured as described above performs data transfer while emphasizing the performance of sequential access and determines whether or not the measurement result is a measurement result of the sequential access on the basis of the measurement condition that is included in the performance information. In addition, the recording and playback device 20 selects a data transfer control mode on the basis of the measurement result of sequential access and performs function limitation in the data transfer.

The recording and playback device 20 performs limitation for the number of programs that can be simultaneously recorded, simultaneous operations, automatic recording function, etc., as the function limitation. In the limitation of the number of programs that can be simultaneously recorded, for example, the number of programs that can be recorded when the performance of the external storage device is low is one program, and the number of programs that can be simultaneously recorded when the performance of the external storage device is high is a plurality of programs. In addition, in the limitation of simultaneous operations, for example, one of a recording operation and a playback operation is selectively performed when the performance of the external storage device is low, and both of the recording operation and the playback operation simultaneously can be performed when the performance of the external storage device is high. In the limitation of automatic recording function, for example, when the performance of the external storage device is low, the automatic recording function is inactivated so that the recording operation is not performed during playback of a recorded program. In addition, when the performance of the external storage device is high, the automatic recording function is activated so that a reservation program can be recorded to the external storage even during playback of a recorded program.

In addition, the recording and playback device 20 executes a performance measurement program when performance information is not recorded to the external storage device or when recorded information is not available information, for example, when the recorded information is a measurement result of random access, etc. In the performance measurement program, the performance of sequential access is measured. In addition, the recording and playback device 20 generates performance information including a measurement result and a measurement condition of sequential access, and records the generated performance information to the user's area of the external storage device.

When the recording and playback device 20 performs the operation as described above, the recording and playback device 20 can perform data transfer while taking advantaging of the performance of the external storage device in line with the operation of the recording and playback device 20. In addition, when performance information is not recorded to the external storage device, the performance in line with the operation of the recording and playback device 20 is measured to record performance information that indicates the measurement result to the user's area of the external storage device. Thus, when an external storage device is connected to the recording and playback device 20 or when an external storage device is connected to another recording and playback device, data transfer can be performed easily without measuring the performance while taking advantaging of the performance of the external storage device. In addition, an existing external storage device may be utilized as-is for the data transfer.

### 3. Second Embodiment

Next, as a second embodiment, a case is described in which data transfer is performed while emphasizing the performance of random access in the electronic apparatus 10. For example, when recording and playback of content data are performed in response to content requests from a plurality of apparatuses, the performance of random access in the external storage device 60 is emphasized because transfer processing of the content data in response to the request is desired.

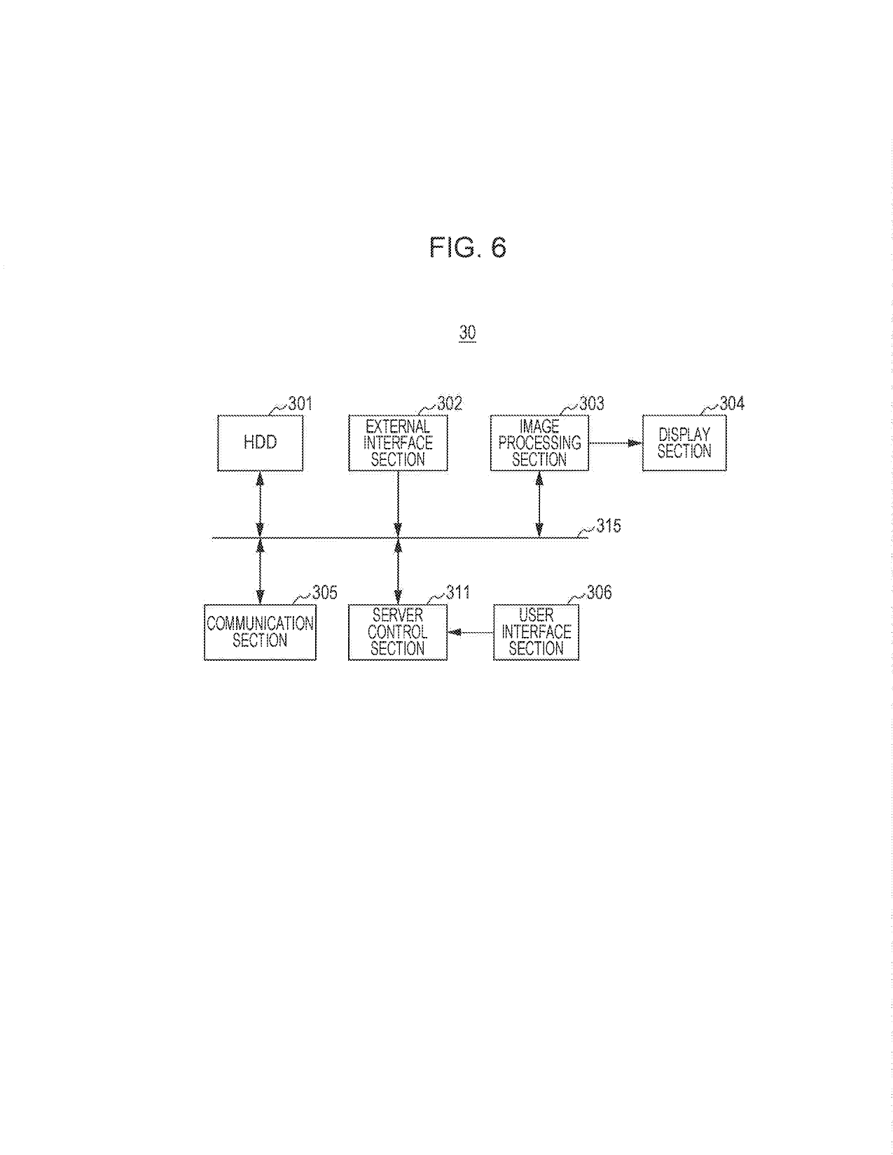

FIG. 6 is a diagram illustrating a schematic configuration of the electronic apparatus in which the performance of random access is emphasized, for example, a schematic configuration of a server device that performs recording and playback of a program in response to requests from a plurality of apparatuses.

A server device 30 includes a HDD 301, an external interface section 302, an image processing section 303, a display section 304, a communication section 305, a user interface section 306, and a server control section 311, and these configuration elements are connected to each other through an internal bus 315.

The HDD 301 holds content data, various programs that are executed by the server control section 311, data to be processed, etc. The HDD 301 is used as a work area when the transfer processing of content data is performed.

The external interface section 302 is an interface that is used to connect the server device 30 with an external storage device, etc. The external interface section 302 is, for example, a generic interface such as the above-described USB, eSATA, IEEE1394, and LightPeak.

For example, the display section 304 that is constituted by a display device such as a liquid crystal display (LCD) is connected to the image processing section 303. The image processing section 303 causes an image of an operation menu, an operations state, etc. of the server device 30 to be displayed on a screen of the display section 304 in accordance with an instruction from the server control section 311.

The communication section 305 connects the server device 30 to a network through a wireless or wired transmission path.

The user interface section 306 is constituted for example, by an input device such as a keyboard and a mouse. The user interface section 306 generates an operation signal in accordance with a user operation by the keyboard, the mouse, etc. and transmits the generated signal to the server control section 311.

The server control section 311 includes a CPU, a ROM, and a RAM. The memory stores a program that is executed by the CPU, program data, etc. The programs that are stored in the memory and the HDD 301 are executed when the CPU reads the programs. By executing the programs, for example, the CPU controls an operation of the server device 30 in accordance with an operation signal that is input from the user interface section 306 and performs recording and playback of content data in response to a content request from an external apparatus.

In addition, the server control section 311 controls recording of data to the external storage device 60, controls reading of the data that is recorded to the external storage device 60, performs processing for obtaining performance information from the external storage device, and controls data transfer based on the obtained performance information. In addition, the server control section 311 performs processing for measuring the performance of the external storage device 60, performs processing for generating performance information that includes a measurement result and a measurement condition of the performance, and controls recording of the generated performance information to the external storage device 60, etc.

The server device 30 that is configured as described above emphasizes the performance of random access of the external storage device because the server device 30 is desired to perform recording and playback of contents in response to requests that are randomly issued from a plurality of external apparatuses. The server device 30 determines whether the measurement result is a measurement result of random access on the basis of the measurement condition included in the performance information that is recorded to the external storage device. In addition, the server device 30 selects a data transfer control mode on the basis of the measurement result of random access and performs function limitation in data transfer.

The server device 30 performs limitation for the number of programs that can be simultaneously distributed, contents to be distributed, and recording of contents, etc. that is being distributed, as the function limitation. In the limitation of the number of programs that can be simultaneously distributed, for example, the number of programs that can be distributed when the performance of the external storage device is low is one program, and the number of programs that can be simultaneously distributed when the performance of the external storage device is high is a plurality of programs. In addition, in the limitation of contents to be distributed, for example, distribution of a movie is terminated when the performance of the external storage device is low, and distribution of a high-definition movie can performed when the performance of the external storage device is high. In the limitation of recording of contents, etc. that is being distributed, for example, a recording operation of contents is not performed during distribution of contents when the performance of the external storage device is low. In addition, contents of which a recording request is issued from the external apparatus are recorded even during distribution of contents when the performance of the external storage device is high.

In addition, the server device 30 executes a performance measurement program when performance information is not recorded to the external storage device or when recorded information is not available information, for example, when the recorded information is a measurement result of sequential access, etc. In the performance measurement program, the performance of random access is measured. In addition, the server device 30 generates performance information including a measurement result of and a measurement condition of random access and records the generated performance information to the external storage device.

When the server device 30 performs the operation as described above, the server device 30 can performs data transfer while taking advantage of the performance of external storage device in accordance with the above-described operation of the server device 30. In addition, when the performance information is not recorded to the external storage device, the performance in accordance with the operation of the server device 30 is measured to record performance information that indicates the measurement result to the user's area of the external storage device. Thus, when an external storage device is connected to another server device, data transfer can be easily performed without measuring the performance while taking advantage of the performance of the external storage device. In addition, an existing external storage device may be utilized as-is for the data transfer.

In the above-described embodiments, performance information of sequential access is utilized in the recording and playback device 20, and performance information of random access is utilized in the server device 30. The electronic apparatus may utilize performance information that meets an object, the performance information is not limited to that of the sequential access or random access. In addition, when the electronic apparatus does not obtain desired performance information, the electronic apparatus may measure access performance that meets an object of the electronic apparatus, as performance measurement.

A series of pieces of processing that are described in this specification can be executed by hardware, software, or the combination of hardware and software. When the processing is executed by software, a program to which a processing sequence is recorded may be executed so as to be installed on a memory that is integrated to dedicated hardware in a computer. In addition, the program may be executed so as to be installed on a generic computer that can execute various pieces of processing.

For example, the program may be recorded to a recording medium such as a hard disk and a ROM beforehand. In addition, the program may be temporarily or permanently stored and recorded in and to a removable recording medium such as a flexible disk, a compact disc read only memory (CD-ROM), a magneto optical (MO) disk, a DVD, a magnetic disk, and a semiconductor memory card. Such removable recording medium may be provided as so-called package software.

In addition, the program may be transferred wirelessly or by a wire from a download site to a computer through a network such as a local area network (LAN) or the Internet in addition to the case of being installed on the computer from the removable recording medium. In the computer, the program that is transferred as described above is received and may be installed on a recording medium such as a built-in hard disk.

The present technology should not be construed as limited to the above-described embodiments. The embodiments discloses the present technology in the form of illustration, and it is obvious for those skilled in the art that modifications and substitutions of the embodiments may be made without departing from the scope of the present technology. That is, in order to determine the gist of the present technology, it should be taken into consideration the scope of the claims.

In addition, an electronic apparatus according to the present technology may employ the following configuration.

(1) An electronic apparatus including:

an information obtaining section that obtains performance information from an external storage device; and

a control section that performs data transfer control based on the performance information that is obtained by the information obtaining section.

(2) The electronic apparatus according to (1), wherein

the control section performs performance measurement of the external storage device, generates performance information including a measurement result, and records the generated performance information to the external storage device when the information obtaining section does not obtain the performance information from the external storage device.

(3) The electronic apparatus according to (2), wherein

the control section records the generate performance information to a user's area of the external storage device.

(4) The electronic apparatus according to any one of (1) to (3), wherein

the control section performs data transfer control based on the performance information when the control section determines that the performance information that is obtained in the information obtaining section is available.

(5) The electronic apparatus according to (4), wherein

the performance information includes a performance measurement condition and a performance measurement result, and

the control section determines that the performance information is available when the performance measurement condition that is included in the performance information meets a desired condition.

(6) The electronic apparatus according to (4) or (5), wherein

the control section performs performance measurement of the external storage device, generates performance information including a measurement result, and records the generated performance information to the external storage device when the control section does not determine that the performance information that is obtained in the information obtaining section is available.

(7) The electronic apparatus according to any one of (1) to (6), wherein

the control section measures access performance that meets an object of the electronic apparatus as the performance measurement.

(8) The electronic apparatus according to any one of (1) to (7), wherein

the control section performs function limitation based on the performance information in data transfer control for the external storage device.

(9) The electronic apparatus according to (8), wherein

the control section limits content amounts that are recorded and/or played back simultaneously for the external storage device, as the function limitation.

The present disclosure contains subject matter related to that disclosed in Japanese Priority Patent Application JP 2012-7877 filed in the Japan Patent Office on Jan. 18, 2012, the entire contents of which are hereby incorporated by reference.

What is claimed is:

1. An electronic apparatus comprising:
an information obtaining section that obtains performance information from an external storage device; and
a control section that performs data transfer control based on the performance information that is obtained by the information obtaining section.

2. The electronic apparatus according to claim 1, wherein
the control section performs performance measurement of the external storage device, generates performance information including a measurement result, and records the generated performance information to the external storage device when the information obtaining section does not obtain the performance information from the external storage device.

3. The electronic apparatus according to claim 2, wherein
the control section records the generate performance information to a user's area of the external storage device.

4. The electronic apparatus according to claim 1, wherein
the control section performs data transfer control based on the performance information when the control section determines that the performance information that is obtained in the information obtaining section is available.

5. The electronic apparatus according to claim 4, wherein
the performance information includes a performance measurement condition and a performance measurement result, and
the control section determines that the performance information is available when the performance measurement condition that is included in the performance information meets a desired condition.

6. The electronic apparatus according to claim 4, wherein
the control section performs performance measurement of the external storage device, generates performance information including a measurement result, and records the generated performance information to the external storage device when the control section does not determine that the performance information that is obtained in the information obtaining section is available.

7. The electronic apparatus according to claim 1, wherein
the control section measures access performance that meets an object of the electronic apparatus as the performance measurement.

8. The electronic apparatus according to claim 1, wherein
the control section performs function limitation based on the performance information in data transfer control for the external storage device.

9. The electronic apparatus according to claim 8, wherein
the control section limits content amounts that are recorded and/or played back simultaneously for the external storage device as the function limitation.

10. A data transfer control method comprising:
obtaining performance information from an external storage device; and
performing data transfer control based on the obtained performance information.

11. A program that controls data transfer with an external storage device in a computer, the program causing the computer to execute a procedure comprising:
obtaining performance information from the external storage device; and
performing data transfer control based on the obtained performance information.
